(19) United States
(12) Patent Application Publication
(10) Pub. No.: US 2015/0170544 A1
(43) Pub. Date: Jun. 18, 2015

(54) SYSTEM AND METHOD FOR INSTINCTIVELY LEARNING AND DRIVING VEHICLE

(71) Applicant: YU CHIH MIN, NEW TAIPEI CITY (TW)

(72) Inventor: YU CHIH MIN, NEW TAIPEI CITY (TW)

(21) Appl. No.: 14/107,113

(22) Filed: Dec. 16, 2013

(51) Int. Cl. G09B 19/16

(52) U.S. Cl. CPC G09B 19/167

(57) ABSTRACT

Disclosed are a system and a method for instinctively learning and driving a vehicle, in which a control system of a vehicle is provided with a simulation control device. The simulation control device includes an accelerator pedal control circuit, a brake pedal control circuit, a travel schedule memory, a random event signal generator, and a processor unit. The system further includes an image taking device, which is connected to the processor unit to pick up an external random event signal occurring around the vehicle and transmit the external random event signal to the processor unit.

### BACKGROUND OF THE INVENTION

1. Field of the Invention

The present invention relates to a design of a virtual reality simulation system, and in particular to a system and a method for instinctively learning and driving a vehicle.

2. The Related Arts

The conventional way of driver's education or driving training is generally conducted by an instructor who sits in the front passenger's seat to instruct and help a structure to practice and learn driving. A synchronized brake pedal is provided under the front passenger's seat to allow the instructor to stop the car when the student gets loss of the control of the car due to excessively strained or simply unfamiliarity. The student, who is under the instruction of the instructor to practice driving, is generally told to first place his or her right foot on the brake pedal to step down the brake pedal and then shift the gearshift pole to the D position and release the hand brake. For safety purposes, particularly of new students, the instructors may instruct the student to release the brake pedal with still with his or her foot sticking to the brake pedal and not stepping down the accelerator pedal, whereby the car is allowed to start moving in a very low speed, and practicing and training of various skills of driving is thus conducted in such a condition, such as S-shaped path driving, backing up, parallel parking, and on-road driving.

Although this is effective in training a student to practice driving skills, the student often gets used to place his or her right foot on the brake pedal. Further, in taking a driver's license examination, due to such a habit, the student will simply place his or her foot on the brake pedal. The student is thus constrained from properly stepping down the accelerator pedal by the inside sense of insecurity and also the feeling of acceleration induced at the time when the accelerator pedal is stepped down. When the student overcomes the psychological disturbance to start his or her road driving, two types of situations may occur, which are situations that can be expected and situations that cannot get aware in advance (sudden events). For the situations that can be expected, the student may make a proper decision. For example, when the student who is driving the can in a road encounters a red light ahead, the student can properly determine to move his or her foot from the accelerator pedal to the brake pedal to stop the car.

In an unexpected situation (such as a sudden event), the student's action may lead to risks. For example, when the student who is driving the can in a road encounters a red light ahead, the student determines to move his or her foot from the accelerator pedal to the brake pedal to stop the car, but an unexpected situation happens (such as an sudden event where a stone is flying toward the student), the student can no longer makes a proper decision as to how to act and the student will yield to his or her habit and react instinctively to follow what he or she learned or practiced in the driver's tuition to step down whatever pedal his or her foot is placed on, which may be the accelerator pedal and unexpected acceleration of the car results. Consequently, a major traffic accident occurs.

Thus, it is an issue to be addressed in the related businesses.

### SUMMARY OF THE INVENTION

However, the traditional way of driver's education or training is generally reliant on oral instructions given by an instructor and self-practicing performed by the student. It is generally impossible for the driver tuition student to directly and efficiently learn the skills that the instructors intend to teach and it is also impossible for the student to learn how to driver safely.

The present inventor, based on his years' experience of instructing driver education students, develops interactive practicing device for driver tuition and for a more advanced purpose, a system and a method for instinctively learning and driving vehicle are provided.

Thus, an object of the present invention is to provide a system and a method for instinctively learning and driving vehicle, which trains driver tuition student to make proper decision in an unexpected situation by using a simulation control device.

Another object of the present invention is to provide a system and a method for instinctively learning and driving vehicle, which trains a driver tuition student to overcome the sense of insecurity in stepping down an accelerator pedal by using a simulation control device.

The technical solution adopted in the present invention to overcome the problems of the prior art is that a control system of a vehicle is provided with a simulation control device. The simulation control device comprises an accelerator pedal control circuit, a brake pedal control circuit, a travel schedule memory, a random event signal generator, and a processor unit. When a user selects a travel schedule to conduct training for practicing driving, the processor unit follows the selected travel schedule and corresponding simulation parameters to control the accelerator pedal control circuit to generate an accelerator control signal, whereby the user may control the accelerator pedal of the vehicle. As such, the user can be trained to familiarize the sense of acceleration when stepping down the accelerator pedal so that the sense of insecurity of the user caused by psychological factors in stepping down the accelerator pedal can be eliminated.

In another embodiment, the present invention provides a system and a method for instinctively learning and driving a vehicle, which further comprises an image taking device, which picks up an external random event signal occurring around the vehicle and transmits the external random event signal to the processor unit. The image taking device supplies the external random event signal to train a driver to make a proper decision in an unexpected situation.

### BRIEF DESCRIPTION OF THE DRAWINGS

The present invention will be apparent to those skilled in the art by reading the following description of preferred embodiments of the present invention, with reference to the attached drawings, in which:

FIG. 1 is a block diagram of a system and a method for instinctively learning and driving a vehicle according to the present invention;

FIG. 2 is a perspective view showing the system and the method for instinctively learning and driving a vehicle according to the present invention;

FIG. 3 is a schematic view showing the generation of a random event signal;

FIG. 4 is a block diagram of the system and the method for instinctively learning and driving a vehicle according to the present invention combined with a display screen;

FIG. 5 is a perspective view showing a simulation system according to the present invention;

FIG. 6 is a schematic view showing the generation of an external random event signal; and

FIG. 7 is a flow chart of a system and a method for instinctively learning and driving a vehicle according to the present invention.

### DETAILED DESCRIPTION OF THE PREFERRED EMBODIMENTS

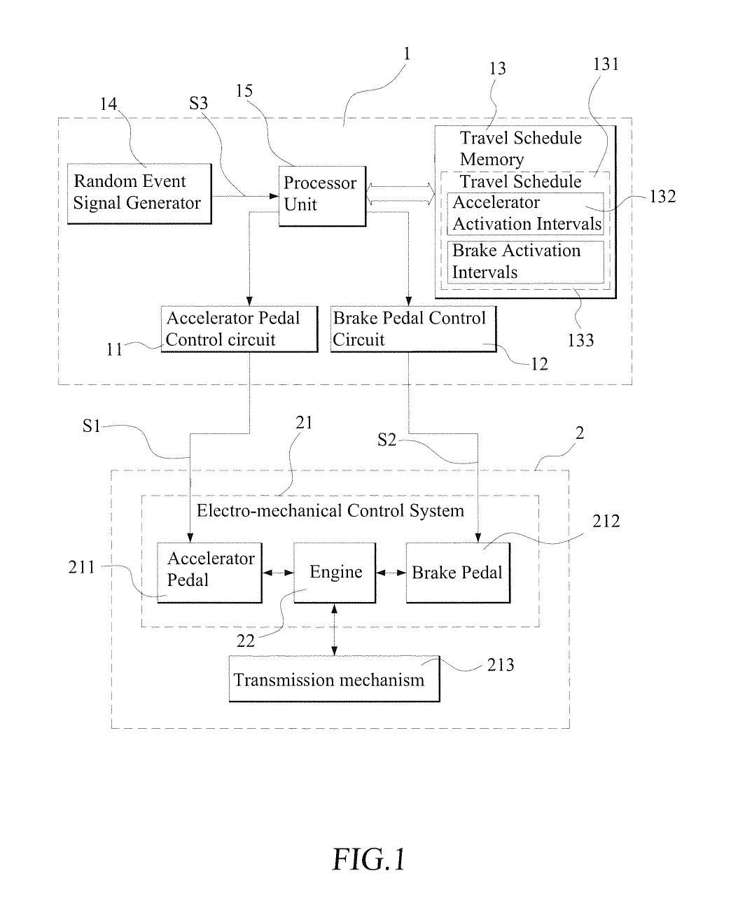

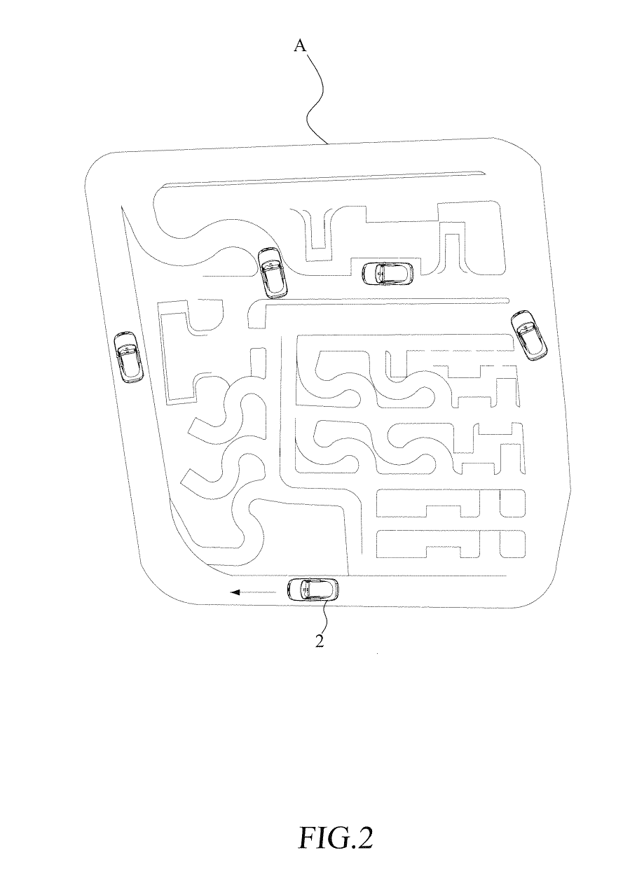

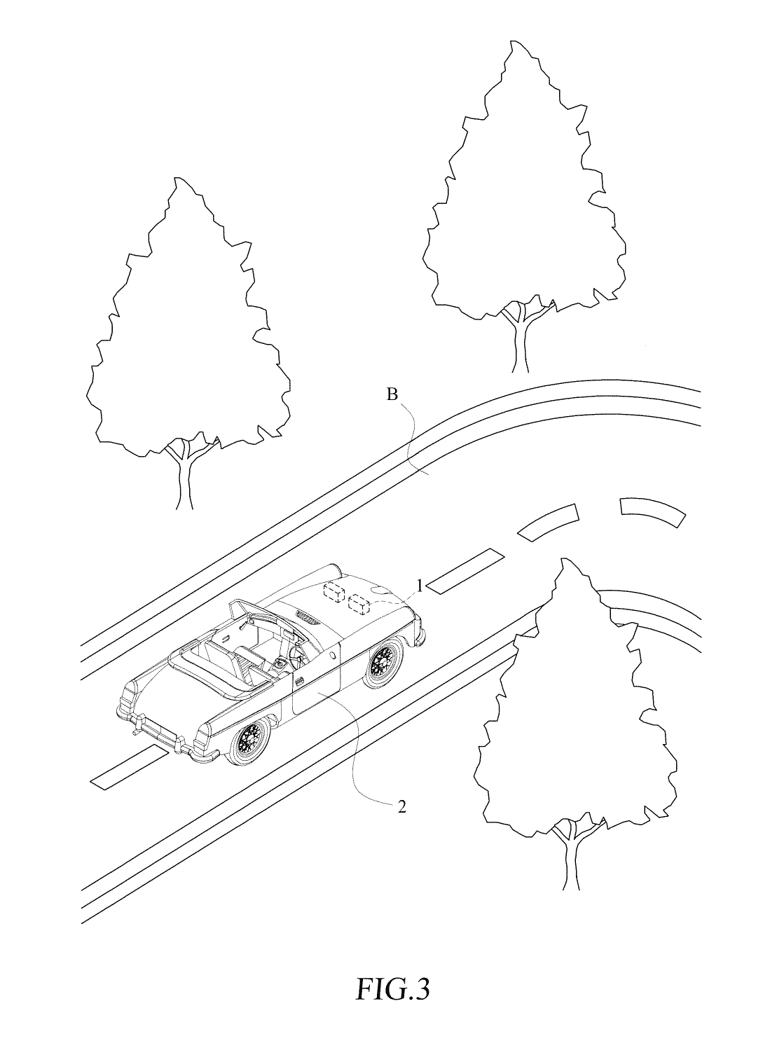

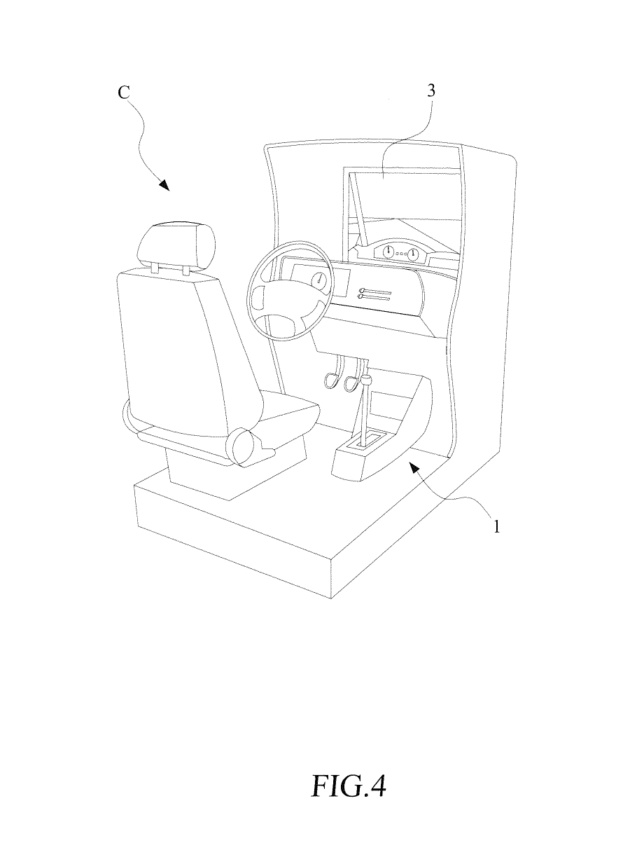

With reference to the drawings and in particular to FIGS. 1, 2, 3 and 4, the present invention provides a system and a method for instinctively learning and driving a vehicle, which comprises a simulation control device 1 arranged in a control system of a vehicle. The simulation control device 1 comprises an accelerator pedal control circuit 11, a brake pedal control circuit 12, a travel schedule memory 13, a random event signal generator 14, and a processor unit 15. The accelerator pedal control circuit 11 and the brake pedal control circuit 12 are respectively connected to an accelerator pedal 211 and a brake pedal 212 of the electro-mechanical control system 21 of the vehicle 2. The vehicle 2 comprises an electro-mechanical control system 21 and a transmission mechanism 213. The electro-mechanical control system 21 comprises an accelerator pedal 211, a brake pedal 212, and an engine 22. The vehicle 2 can be operated to drive in one of a driver tuition field A as shown in FIG. 2, a road B as shown in FIG. 3, or a simulation chamber C as shown in FIG. 4.

The accelerator pedal control circuit 11 generates an accelerator control signal S1. The accelerator pedal control circuit 11 is controlled by the processor unit 15 to generate the accelerator control signal S1 for controlling the accelerator pedal 211 of the vehicle 2.

The brake pedal control circuit 12 generates a brake control signal S2. The brake pedal control circuit 12 is controlled by the processor unit 15 to generate the brake control signal S2 for controlling the brake pedal 212 of the vehicle 2.

The travel schedule memory 13 stores therein at least one travel schedule 131. Each travel schedule 131 comprises a plurality of accelerator activation intervals 132 and brake activation intervals 133.

The random event signal generator 14 generates a random event signal S3.

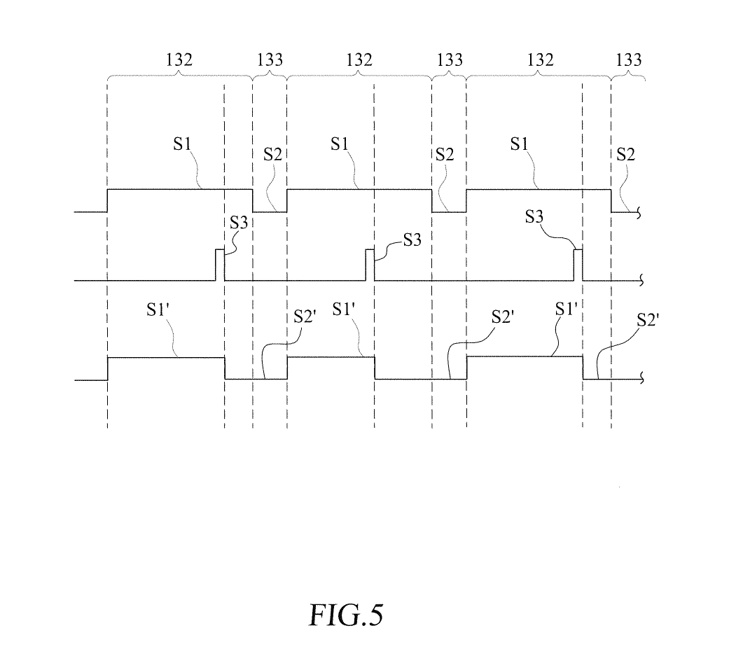

With reference to FIGS. 1 and 5, the processor unit 15 is operable to follow a selected travel schedule 131 and a plurality of corresponding accelerator activation intervals 132 to control the accelerator pedal control circuit 11 to generate the accelerator control signal S1 to control the accelerator pedal 211 of the vehicle 2 and, in response to receipt of the random event signal S3, the processor unit 15 interrupts the travel schedule 131 and the accelerator control signal S1 and is switched to the brake activation intervals 133 to control the brake pedal control circuit 12 to generate the brake control signal S2 to control the brake pedal 212 of the vehicle 2.

When a user selects a travel schedule 131 to conduct a simulation operation for practicing driving, the processor unit 15 is operated to follow the selected travel schedule 131 and a plurality of associated accelerator activation intervals 132 to control the accelerator pedal control circuit 11 to generate the accelerator control signal S1. The user is then allowed to control the accelerator pedal of the vehicle 2 so as to familiarize the trainee with the sense of acceleration induced in stepping down the accelerator pedal and thus eliminate the sense of insecurity of the trainee caused by psychological factors in stepping down the accelerator pedal.

When the trainee steps down the accelerator pedal, the random event signal generator 14 may generate a random event signal S3 (such as a sudden event where a stone is flying toward the trainee or a pedestrian suddenly walks across the road in violation of the stop signal of a red light) during the accelerator activation intervals 132. The random event signal S3 enables the trainee to practice reaction in an unexpected situation by allowing the processor unit 15 to interrupt the travel schedule 131 and the accelerator control signal S1 and generate the brake control signal S2, so that the trainee may control the brake pedal of the vehicle 2. Because the random event signal S3 is generated during the accelerator activation intervals 132, and therefore a series of actual accelerator control signals S1′ and a series of actual brake control signals S2′ are generated. As such, the trainee can practice his or her reaction in an unexpected situation where a proper decision may not be made and unexpected acceleration of the vehicle may occur.

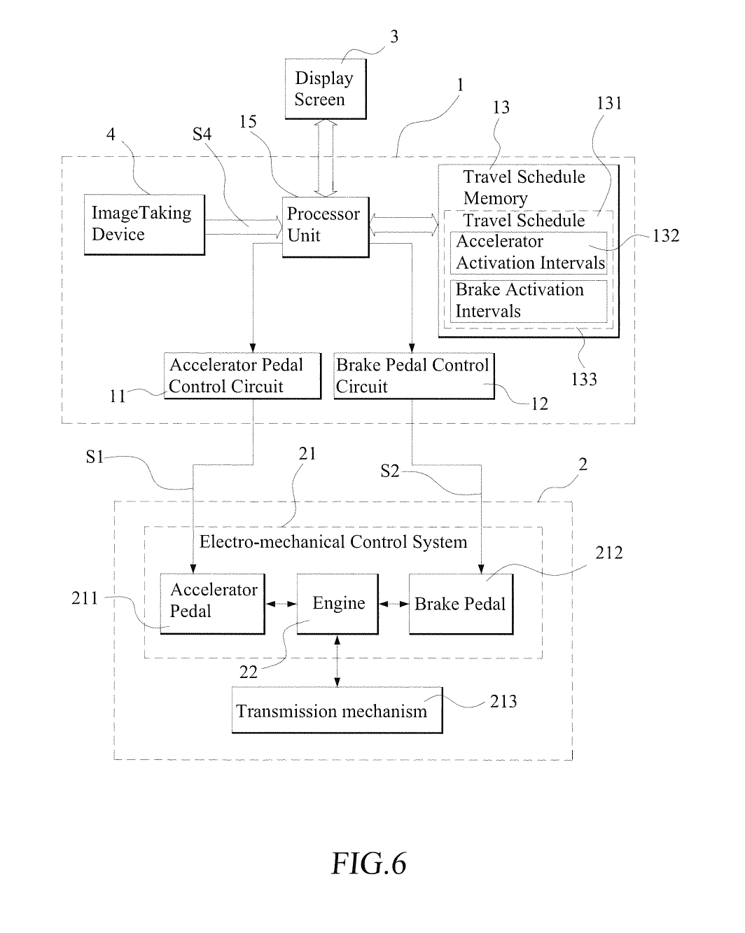

Also referring to FIG. 6, the instant embodiment comprises components, most of which are identical to those of the first embodiment, so that similar components are designated with the same reference numerals for consistency. In the instant embodiment, the present invention provides a system and a method for instinctively learning and driving a vehicle, which comprises a simulation control device 1 arranged in a control system of the vehicle. The simulation control device 1 comprises an accelerator pedal control circuit 11, a brake pedal control circuit 12, a travel schedule memory 13, a processor unit 15, and a display screen 3. The vehicle of the instant embodiment is a simulation chamber C and the simulation chamber C comprises a display screen 3. The display screen 3 is electrically connected to the processor unit 15. The system for instinctively learning and driving a vehicle further comprises an image taking device 4, which picks up an external random event signal S4 outside the vehicle and transmits the external random event signal S4 to the processor unit 15.

When a user selects a travel schedule 131 to conduct a simulation operation for practicing driving, the processor unit 15 is operated to follow the selected travel schedule 131 and a plurality of associated accelerator activation intervals 132 to control the accelerator pedal control circuit 11 to generate the accelerator control signal Sl. The user is then allowed to control the accelerator pedal of the vehicle so as to familiarize the trainee with the sense of acceleration induced in stepping down the accelerator pedal and thus eliminate the sense of insecurity of the trainee caused by psychological factors in stepping down the accelerator pedal.

When the trainee steps down the accelerator pedal, the image taking device 4 applies an external random event signal S4 (such as a major accident or an sudden event where the traffic light suddenly falls down) to train the trainee in an unexpected situation, where the processor unit 15, within the accelerator activation intervals 132, receives the external random event signal S4 generated by the image taking device 4 and the processor unit 15 interrupts the accelerator control signal S1 and instead, generates the brake control signal S2 to control the brake pedal 212 of the vehicle 2. The trainee may control the brake pedal of the vehicle and as such, the trainee can practice his or her reaction in an unexpected situation where a proper decision may not be made and unexpected acceleration of the vehicle may occur.

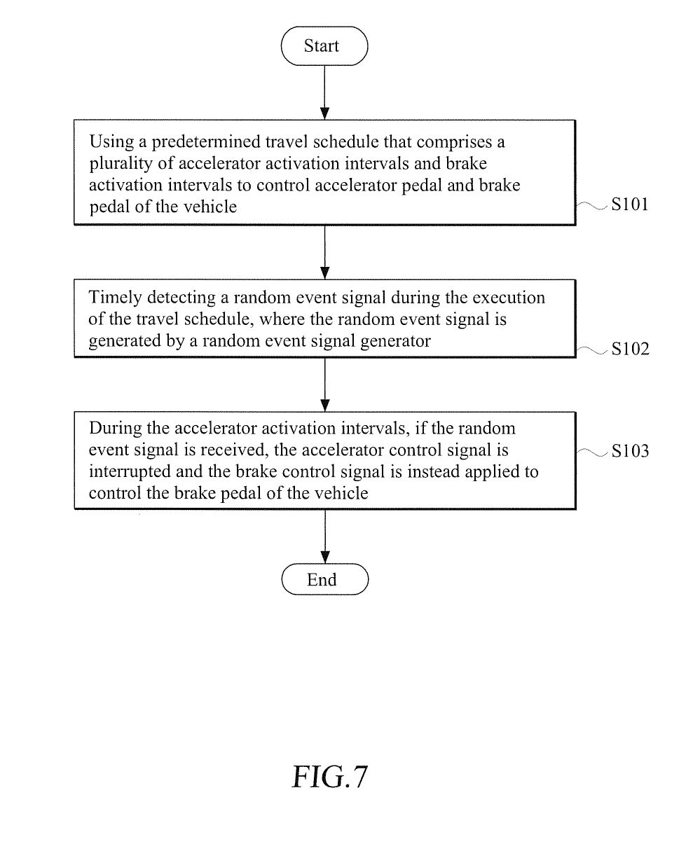

Also referring to FIG. 7, in an embodiment of the present invention, a vehicle is provided with an accelerator pedal control circuit 11 and a brake pedal control circuit 12 in an electro-mechanical control system 21 thereof, wherein the accelerator pedal control circuit 11 selectively generates an accelerator control signal S1 to control an accelerator pedal 211 of the vehicle and the brake pedal control circuit 12 selectively generates a brake control signal S2 to control a brake pedal 212 of the vehicle. A method comprises the following steps: using a predetermined travel schedule 131 that comprises a plurality of accelerator activation intervals 132 and brake activation intervals 133 to control the accelerator pedal 211 and the brake pedal 212 of the vehicle (step S101); timely detecting a random event signal S3 during the execution of the travel schedule 131 (step S102), where the random event signal S3 is generated by a random event signal generator 14. During the accelerator activation intervals 132, if the random event signal S3 is received, the accelerator control signal S1 is interrupted and the brake control signal S2 is instead applied to control the brake pedal 212 of the vehicle (step S103). The method for instinctively learning and driving a vehicle according to the present invention can be a method that the vehicle is operated to drive in one of a driver tuition field, a road or a simulation chamber.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A system for instinctively learning and driving a vehicle, which comprises a simulation control device arranged in an electro-mechanical control system of a vehicle, the simulation control device comprising:
an accelerator pedal control circuit, which generates an accelerator control signal to control an accelerator pedal of the vehicle;
a brake pedal control circuit, which generates a brake control signal to control a brake pedal of the vehicle;
a travel schedule memory, which comprises at least one travel schedule stored therein to be selected and used, each travel schedule comprising a plurality of accelerator activation intervals and brake activation intervals;
a random event signal generator, which generates a random event signal; and
a processor unit, which is connected to the accelerator pedal control circuit, the brake pedal control circuit, the travel schedule memory, and the random event signal generator;
wherein the processor unit follows the selected travel schedule to control, in the accelerator activation intervals, the accelerator pedal control circuit to generates the accelerator control signal for controlling the accelerator pedal of the vehicle and to control, in the brake activation intervals, the brake pedal control circuit to generate the brake control signal for controlling the brake pedal of the vehicle;
and wherein the random event signal generated by the random event signal generator is received by the processor unit during the accelerator activation intervals, the processor unit interrupts the accelerator control signal and switches to the brake control signal to control the brake pedal of the vehicle.

2. The system as claimed in claim 1, further comprising an image taking device, which is connected to the processor unit to pick up an image of an object around the vehicle and generate an external random event signal and transmit the external random event signal to the processor unit, whereby when the processor unit receives the external random event signal generated by the image taking device in the accelerator activation intervals, the processor unit interrupts the accelerator control signal and switches to the brake control signal to control the brake pedal of the vehicle.

3. The system as claimed in claim 1, wherein the vehicle is operated to drive in one of a driver tuition field and a road.

4. The system as claimed in claim 1, wherein the vehicle is arranged in an environment of a simulation chamber, environment of the simulation chamber comprising a display screen, the display screen being electrically connected to the processor unit.

5. A method for instinctively learning and driving a vehicle, which is applied to a vehicle having an electro-mechanical control system that comprises an accelerator pedal control circuit and a brake pedal control circuit, wherein the accelerator pedal control circuit is operable to generate an accelerator control signal to control an accelerator pedal of the vehicle and the brake pedal control circuit is operable to generate a brake control signal to control a brake pedal of the vehicle, the method comprising the following steps:
(a) using a predetermined travel schedule that comprises a plurality of accelerator activation intervals and brake activation intervals to control the accelerator pedal and the brake pedal of the vehicle;
(b) timely detecting a random event signal during the execution of the travel schedule; and
(c) during the accelerator activation intervals, if the random event signal is received, interrupting the accelerator control signal and applying the brake control signal to control the brake pedal of the vehicle.

6. The method as claimed in claim 5, wherein the random event signal is generated by a random event signal generator.

7. The method as claimed in claim 5, wherein the random event signal is generated by an image taking device taking an image of an object around the vehicle.

8. The method as claimed in claim 5, wherein the vehicle is operated to drive in one of a driver tuition field and a road.

9. The method as claimed in claim 5, wherein the vehicle is arranged in an environment of a simulation chamber.
